(19) United States
(12) Patent Application Publication
(10) Pub. No.: US 2026/0166852 A1
(43) Pub. Date: Jun. 18, 2026

(54) COMPOSITE ELEMENT AND MOBILE DEVICE

(71) Applicant: LARGAN PRECISION CO., LTD., Taichung City (TW)

(72) Inventors: Pei-Chi CHANG, Taichung City (TW); Yu-Jie HONG, Taichung City (TW); Chun-Hung TENG, Taichung City (TW)

(21) Appl. No.: 19/413,184

(22) Filed: Dec. 9, 2025

(30) Foreign Application Priority Data
Dec. 16, 2024 (TW) 113148929

(51) Int. Cl. B32B 15/01

(52) U.S. Cl. CPC B32B 15/017

(57) ABSTRACT

A composite element includes a composite structure. The composite structure includes a substrate and a composite layer, and the composite layer is disposed on a surface of the substrate. A material of the substrate is an aluminum alloy, and the composite layer includes an alloy layer. The alloy layer includes at least three metals, and the at least three metals include a zirconium, a copper and an aluminum.

### RELATED APPLICATIONS

This application claims priority to Taiwan Application Serial Number 113148929, filed Dec. 16, 2024, which is herein incorporated by reference.

### BACKGROUND

### Technical Field

The present disclosure relates to a composite element and a mobile device. More particularly, the present disclosure relates to a composite element with excellent overall durability and a mobile device with the composite element.

### Description of Related Art

Mobile devices are prone to scratches due to frequent carrying, which can result in noticeable damage to their surface. To avoid the mobile device resulting damage on the surface, user add-on a protective case on the mobile device. However, the protective case often has defects such as being too heavy and lacking in hardness.

Therefore, in order to satisfied demand of user for protection of mobile device, it is necessary to actively develop a structure which has both thin and high hardness.

### SUMMARY

According to one aspect of the present disclosure, a composite element includes a composite structure. The composite structure includes a substrate and a composite layer, and the composite layer is disposed on a surface of the substrate. A material of the substrate is an aluminum alloy, and the composite layer includes an alloy layer. The alloy layer includes at least three metals, the at least three metals include a zirconium, a copper and an aluminum. The composite element has a turning zone. When a total length of the composite layer in the turning zone is LCc, a length of the turning zone is Lc, a thickness of the alloy layer is Ta, and a thickness of the substrate is Ts, the following conditions are satisfied: 0.75≤LCc/Lc; and 0.50≤Ta/Ts≤1.00.

According to another aspect of the present disclosure, a mobile device includes the composite element according to the aforementioned aspect, the mobile device is a cell phone or a tablet computer.

According to further another aspect of the present disclosure, a composite element includes a composite structure. The composite structure includes a substrate and a composite layer, and the composite layer is disposed on a surface of the substrate. The composite layer includes an alloy layer. The alloy layer includes at least three metals, the at least three metals include a zirconium, a copper and an aluminum. When an area of the composite layer in the composite element is Ac, an area of the substrate in the composite element is As, a thickness of the alloy layer is Ta, and a thickness of the substrate is Ts, the following conditions can be satisfied: 0.200≤Ac/As; and 0.20≤Ta/Ts≤2.00.

According to still another aspect of the present disclosure, a mobile device includes the composite element according to the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a front side of the mobile device according to the Example 1 of the present disclosure.

FIG. 2 is a schematic view of the composite element of the mobile device in FIG. 1 observed from the short edge area.

FIG. 3 is a schematic view of a back side of the mobile device in FIG. 1.

FIG. 4 is a schematic view of a front side of the mobile device according to the Example 13 of the present disclosure.

FIG. 5 is a schematic view of a front side of the mobile device according to the Example 14 of the present disclosure.

FIG. 6 is a side view of the mobile device in FIG. 5.

FIG. 7 is a schematic view of a part of the composite element according to the Example 15 of the present disclosure.

### DETAILED DESCRIPTION

According to a composite element and a mobile device of the present disclosure, the composite element includes a composite structure, and a composite layer including an alloy layer is disposed on a surface of a substrate of the composite structure, so that ideal properties of the composite structure are obtained. By designing a specific thickness ratio between the alloy layer and the substrate, a composite layer with excellent hardness can be ensured in the composite structure, which is favorable for enhancing overall durability of the composite structure.

According to one embodiment of one aspect of the present disclosure, a composite element includes a composite structure. The composite structure includes a substrate and a composite layer, and the composite layer is disposed on a surface of the substrate. A material of the substrate is an aluminum alloy, and the composite layer includes an alloy layer. The alloy layer includes at least three metals, the at least three metals include a zirconium, a copper and an aluminum. The composite element has a turning zone, when a total length of the composite layer in the turning zone is LCc, a length of the turning zone is Lc, a thickness of the alloy layer is Ta, and a thickness of the substrate is Ts, the following conditions are satisfied: 0.75≤LCc/Lc; and 0.50≤Ta/Ts≤1.00. Therefore, by the arrangement of the composite layer including an alloy layer of the surface of the substrate, so that ideal properties of the composite structure are obtained. Furthermore, by designing the ratio of the composite layer in the turning zone, the scratch resistance of the collision-prone areas of the mobile device can be effectively enhanced, and the installation efficiency of the composite structure in the mobile device can be greatly enhanced. Furthermore, by designing the specific thickness ratio of the alloy layer and the substrate, the composite layer with excellent hardness can be ensured in the composite structure, which is favorable for enhancing overall durability of the composite structure.

According to further another embodiment of the present disclosure, a composite element includes a composite structure. The composite structure includes a substrate and a composite layer, and the composite layer is disposed on a surface of the substrate. The composite layer includes an alloy layer. The alloy layer includes at least three metals, and the at least three metals include a zirconium, a copper and an aluminum. When an area of the composite layer in the composite element is Ac, an area of the substrate in the composite element is As, an thickness of the alloy layer is Ta, and a thickness of the substrate is Ts, the following conditions are satisfied: 0.200≤Ac/As; and 0.20≤Ta/Ts≤2.00. Therefore, by the arrangement of the composite layer including an alloy layer of the surface of the substrate, so that ideal properties of the composite structure are obtained. Furthermore, by designing the optimal area ratio of the composite layer, the best scratch resistance with a smaller install area of the composite layer is reached. It is favorable for improving the installation efficiency of the composite layer in the overall area. Furthermore, by designing the specific thickness ratio of the alloy layer and the substrate, the composite layer with excellent hardness can be ensured in the composite structure, which is favorable for enhancing overall durability of the composite structure.

According to the composite element of the present disclosure, when the thickness of the alloy layer is Ta, and the thickness of the substrate is Ts, the following condition can be satisfied: 0.30≤Ta/Ts≤1.50. By designing the specific thickness ratio of the alloy layer and the substrate, the composite layer with excellent hardness can be ensured in the composite structure, which is favorable for enhancing overall durability of the composite structure. Furthermore, the following condition can be satisfied: 0.60≤Ta/Ts≤0.90. Furthermore, the following condition can be satisfied: 0.75≤Ta/Ts≤0.85.

According to the composite element of the present disclosure, when the total length of the composite layer in the turning zone is LCc, and the length of the turning zone is Lc, the following condition can be satisfied: 0.80≤LCc/Lc. By designing the ratio of the composite layer in the turning zone, the scratch resistance of the collision-prone areas of the mobile device can be effectively enhanced, and the installation efficiency of the composite structure in the mobile device can be greatly enhanced. Furthermore, the following condition can be satisfied: 0.85≤LCc/Lc. Furthermore, the following condition can be satisfied: 0.90≤LCc/Lc≤1.00.

According to the composite element of the present disclosure, when the area of the composite layer in the composite element is Ac, and the area of the substrate in the composite element is As, the following condition can be satisfied: 0.350≤Ac/As≤0.450. By designing the optimal area ratio of the composite layer, the best scratch resistance with a smaller install area of the composite layer can be reached. It is favorable for improving the installation efficiency of the composite layer in the overall area. Furthermore, the following condition can be satisfied: 0.005≤Ac/As≤0.060. Furthermore, the following condition can be satisfied: 0.015≤Ac/As≤0.020. Furthermore, the following condition can be satisfied: 0.600≤Ac/As. Furthermore, the following condition can be satisfied: 0.380≤Ac/As≤0.420.

According to the composite element of the present disclosure, when a weight percentage of the zirconium in the alloy layer is Pzr, the following condition can be satisfied: 60%≤Pzr≤90%. By designing the specific ratio of the zirconium in the alloy layer, the composite layer with both hardness and ductility is produced, which prevent the composite layer from being too brittle and easy to peel off. Furthermore, the following condition can be satisfied: 50%≤Pzr. Furthermore, the following condition can be satisfied: 55%≤Pzr<100%. Furthermore, the following condition can be satisfied: 62%≤Pzr≤80%. Furthermore, the following condition can be satisfied: 68%≤Pzr≤75%.

According to the composite element of the present disclosure, when a weight percentage of the copper in the alloy layer is Pcu, the following condition can be satisfied: 5%≤Pcu≤23%. By designing the specific ratio of the copper in the alloy layer, the composite layer with both hardness and ductility is produced, which prevent the composite layer from being too brittle and easy to peel off. Furthermore, the following condition can be satisfied: Pcu≤30%. Furthermore, the following condition can be satisfied: 0%<Pcu≤25%. Furthermore, the following condition can be satisfied: 10%≤Pcu≤21%. Furthermore, the following condition can be satisfied: 12%≤Pcu≤20%. Furthermore, the following condition can be satisfied: 15%≤Pcu≤18%.

According to the composite element of the present disclosure, when a weight percentage of the aluminum in the alloy layer is Pal, the following condition can be satisfied: 2%≤Pal≤6%. By designing the specific ratio of the aluminum in the alloy layer, the composite layer with both hardness and ductility is produced, which prevent the composite layer from being too brittle and easy to peel off. Furthermore, the following condition can be satisfied: Pal≤10%. Furthermore, the following condition can be satisfied: 0%<Pal≤8%. Furthermore, the following condition can be satisfied: 3%≤Pal≤5%.

According to the composite element of the present disclosure, when the weight percentage of the zirconium in the alloy layer is Pzr, the weight percentage of the copper in the alloy layer is Pcu, and the weight percentage of the aluminum in the alloy layer is Pal, the following condition can be satisfied: 95%≤Pzr+Pcu+Pal. By satisfying the total ratio of the zirconium, the copper, and the aluminum in the alloy layer, the properties of the zirconium, the copper, and the aluminum are ensured to dominate the alloy layer, which is favorable for helping the alloy layer maintain appropriate hardness and thermal conductivity. Furthermore, the following condition can be satisfied: 75%≤Pzr+Pcu+Pal. Furthermore, the following condition can be satisfied: 80%≤Pzr+Pcu+Pal. Furthermore, the following condition can be satisfied: 83%≤Pzr+Pcu+Pal. Furthermore, the following condition can be satisfied: 87%≤Pzr+Pcu+Pal. Furthermore, the following condition can be satisfied: 90%≤Pzr+Pcu+Pal. Furthermore, the following condition can be satisfied: 93%≤Pzr+Pcu+Pal≤100%. Furthermore, the following condition can be satisfied: 95%≤Pzr+Pcu+Pal≤98%.

According to the composite element of the present disclosure, when a density of the alloy layer is Da, and a density of the substrate is Ds, the following condition can be satisfied: 1.5≤Da/Ds≤3.5. By designing the specific density ratio of the alloy layer and the substrate, the weight distribution on both sides of the composite structure is ensured, which is favorable for improving the grip feel. Furthermore, the following condition can be satisfied: Da/Ds≤5.0. Furthermore, the following condition can be satisfied: Da/Ds≤4.0. Furthermore, the following condition can be satisfied: 2.0≤Da/Ds≤3.0. Furthermore, the following condition can be satisfied: 2.4≤Da/Ds≤2.5.

According to the composite element of the present disclosure, when a coefficient of thermal conductivity of the alloy layer is TCa, and a coefficient of thermal conductivity of the substrate is TCs, the following condition can be satisfied: 30≤TCs/TCa. By designing the coefficient of thermal conductivity ratio of the substrate to the alloy layer, the substrate is ensured to have better thermal conductivity than the composite layer and the composite layer causing the thermal barrier to the composite structure can be avoid. Furthermore, the following condition can be satisfied: 5≤TCs/TCa. Furthermore, the following condition can be satisfied: 10≤TCs/TCa. Furthermore, the following condition can be satisfied: 60≤TCs/TCa. Furthermore, the following condition can be satisfied: 70≤TCs/TCa≤∞. Furthermore, the following condition can be satisfied: 75≤TCs/TCa≤90.

According to the composite element of the present disclosure, when the coefficient of thermal conductivity of the substrate is TCs, the following condition can be satisfied: 5 W/mK≤TCs. By the arrangement of the specific coefficient of thermal conductivity of the substrate, so that the composite structure achieves excellent thermal conductivity. Furthermore, the following condition can be satisfied: 20 W/mK≤TCs. Furthermore, the following condition can be satisfied: 50 W/mK≤TCs. Furthermore, the following condition can be satisfied: 80 W/mK≤TCs. Furthermore, the following condition can be satisfied: 100 W/mK≤TCs. Furthermore, the following condition can be satisfied: 130 W/mK≤TCs≤∞. Furthermore, the following condition can be satisfied: 180 W/mK≤TCs≤300 W/mK.

According to the composite element of the present disclosure, when the coefficient of thermal conductivity of the alloy layer is TCa, the following condition can be satisfied: 0.5 W/mK≤TCa. By limiting the coefficient of thermal conductivity of the alloy layer, a basic thermal conductivity thereof is ensured, which is favorable for reducing the thermal accumulation of the composite structure. Furthermore, the following condition can be satisfied: 1.0 W/mK≤TCa. Furthermore, the following condition can be satisfied: 1.5 W/mK≤TCa. Furthermore, the following condition can be satisfied: 2.0 W/mK≤TCa≤∞.

According to the composite element of the present disclosure, when a hardness of the alloy layer is Ha, the following condition can be satisfied: 400 HV≤Ha≤1000 HV. By the arrangement of the specific hardness of the alloy layer, the composite structure with the excellent scratch resistance and the excellent abrasion resistance can be provided. Furthermore, the following condition can be satisfied: 300 HV≤Ha. Furthermore, the following condition can be satisfied: 350 HV≤Ha. Furthermore, the following condition can be satisfied: 450 HV≤Ha≤600 HV. Furthermore, the following condition can be satisfied: 500 HV≤Ha≤550 HV.

According to the composite element of the present disclosure, when a hardness of the substrate is Hs, the following condition can be satisfied: Hs≤250 HV. By using the substrate with lower hardness, the substrate is easier to manufacture and process, which is favorable for reducing the difficulty of producing the composite structure. Furthermore, the following condition can be satisfied: Hs≤200 HV. Furthermore, the following condition can be satisfied: 0 HV<Hs≤180 HV. Furthermore, the following condition can be satisfied: 50 HV≤Hs≤150 HV. Furthermore, the following condition can be satisfied: 80 HV≤Hs≤100 HV.

According to the composite element of the present disclosure, when the hardness of the alloy layer is Ha, and the hardness of the substrate is Hs, the following condition can be satisfied: 5.00≤Ha/Hs≤10.00. By designing the specific hardness ratio of the alloy layer and the substrate, the composite layer has better scratch resistance and abrasion resistance than the substrate, which is favorable for improving the installation efficiency of the composite layer. Furthermore, the following condition can be satisfied: 6.00≤Ha/Hs≤8.00. Furthermore, the following condition can be satisfied: 1.50≤Ha/Hs. Furthermore, the following condition can be satisfied: 2.00≤Ha/Hs. Furthermore, the following condition can be satisfied: 2.50≤Ha/Hs. Furthermore, the following condition can be satisfied: 3.00≤Ha/Hs. Furthermore, the following condition can be satisfied: 7.00≤Ha/Hs≤7.50.

According to the composite element of the present disclosure, when the thickness of the alloy layer is Ta, the following condition can be satisfied: 0.5 mm≤Ta≤1.5 mm. By designing the specific thickness of the alloy layer and improving the physical property of the composite structure with smaller alloy layer thickness are favorable for saving material costs. Furthermore, the following condition can be satisfied: 0.30 mm≤Ta. Furthermore, the following condition can be satisfied: 0.10 mm≤Ta. Furthermore, the following condition can be satisfied: Ta≤1.00 mm. Furthermore, the following condition can be satisfied: 0 mm<Ta≤1.00 mm. Furthermore, the following condition can be satisfied: 0.40 mm≤Ta. Furthermore, the following condition can be satisfied: 0.60 mm≤Ta≤1.20 mm. Furthermore, the following condition can be satisfied: 0.70 mm≤Ta≤0.80 mm.

According to the composite element of the present disclosure, the composite structure can further include a buffering layer, the buffering layer is located between the composite layer and the substrate. By placing the buffering layer between the composite layer and the substrate, the substrate with lower hardness can prevent damage from directly impaction on the composite structure, thereby enhancing the durability of the substrate.

According to the composite element of the present disclosure, the composite element can be a middle frame, and the composite element has a long edge area and a short edge area. The scratch resistance and the abrasion resistance of the edges of the mobile device can be effectively enhanced by using the composite element as the middle frame.

According to the composite element of the present disclosure, when a total length of the composite layer in the long edge area is LLc, and a length of the long edge area is LI, the following condition can be satisfied: 0<LLc/LI≤0.15. By designing the ratio of the composite layer in the long edge area, the composite layer achieves excellent scratch resistance with the shorter arranged length, which is favorable for improving the installation efficiency of the composite layer in the long edge area. Furthermore, the following condition can be satisfied: LLc/LI≤0.25. Furthermore, the following condition can be satisfied: LLc/LI≤0.20. Furthermore, the following condition can be satisfied: 0.05≤LLc/LI≤0.10.

According to the composite element of the present disclosure, when a total length of the composite layer in the short edge area is LSc, and a length of the short edge area is Ls, the following condition can be satisfied: 0.05≤LSc/Ls≤0.15. By designing the ratio of the composite layer in the short edge area, the composite layer achieves excellent scratch resistance with the shorter arranged length, which is favorable for improving the install efficiency of the composite layer in the short edge area. Furthermore, the following condition can be satisfied: LSc/Ls≤0.30. Furthermore, the following condition can be satisfied: LSc/Ls≤0.25. Furthermore, the following condition can be satisfied: 0<LSc/Ls≤0.20. Furthermore, the following condition can be satisfied: 0.10≤LSc/Ls≤0.13.

According to the composite element of the present disclosure, the material of the substrate can be an aluminum alloy, a titanium alloy or a stainless steel. The substrate has the basic hardness and the excellent thermal conductivity by setting the material of the substrate to the aluminum alloy, the titanium alloy or the stainless steel.

According to the composite element of the present disclosure, the composite element can be a back panel or a front frame. The scratch resistance and the abrasion resistance of the contact area of the mobile device in the users can be enhanced by disposing the composite element as the back panel or the front frame of the mobile device.

According to the composite element of the present disclosure, the alloy layer can be an amorphous alloy. The amorphous structure is not as brittle as the crystal structure. It is favorable for avoiding the alloy layer from cracking upon impact by setting the alloy layer as the amorphous alloy.

The composite element of the present disclosure can be a frame, a back panel, a case, an upper cover, a lower cover, a press, a button, a gearwheel, a carrousel or a revolving shaft. The frame can be further disposed to the middle frame or the front frame, etc. The composite element can have the turning zone and a side zone. The turning zone is the area that appears curved when the composite element is lying flat from above. The curvature is judged by the radius of curvature of the horizontal cross-section when the composite element is lying flat. The side zone is located between two of the turning zones when the composite element is lying flat. The beginning and the end thereof are straight lines and the overall straight line segment exceeds 50%, wherein the fold line can be considered as the multiple straight lines. The side zone is divided into the long edge area and the short edge area according to the position of the side length in the side zone. The side zone located on the long side of the composite element is the long edge area. The side zone located on the short side of the composite element is the short edge area. When the four sides of the composite element are of equal length, there is no distinction between the long side and the short side. The side zone can be either the long edge area or the short side area. When the composite element is rectangular, the turning zone is the intersection point of the lengths of the two sides of the composite element.

The middle frame of the present disclosure refers to the component used to connect the screen and the back panel (on the side opposite of the screen) of the mobile device.

The composite structure of the present disclosure can include the composite layer and the substrate. The composite layer can be directly or indirectly disposed on the surface of the substrate. When the composite layer is indirectly disposed on the surface of the substrate, the buffering layer can be present between the composite layer and the substrate. A material of the buffering layer can be gas or liquid. For example, the gas can be air, nitrogen, helium, neon, argon, krypton or xenon, etc. The liquid can be water, oil, coolant or glue, etc. When the substrate is the plastic or glass, the composite layer is not easy to dispose on the surface of the substrate. Therefore, an adhesive can be disposed between the substrate and the composite layer, so that the composite layer is indirectly disposed on the surface of the substrate and improving the tightness of the substrate and the composite layer.

The substrate of the present disclosure can be a semiconductor, a metal, a metal compound, an alloy, a glass or a carbon fiber, etc. A material of the semiconductor can be a silicon, a germanium, a gallium arsenide, an indium phosphide, a gallium nitride, a zinc oxide, an aluminum nitride or a silicon carbide. The metal can be a gold, a silver, a copper, an iron, an aluminum, a tin, a nickel, a lead, a zinc, a titanium and a vanadium. The metal compound can be a metal oxide or a metal nitride. In detail, the metal oxide can be an alumina, the metal nitride can be a lithium nitride, a magnesium nitride, an aluminum nitride, a titanium nitride and a tantalum nitride. The alloy can be an aluminum alloy, a titanium alloy or a ferroalloy, wherein the ferroalloy can further be a stainless steel.

The composite layer of the present disclosure can include at least one film layer, at least two film layers or at least three film layers, the at least one film layer, the at least two film layers or the at least three film layers can include an intermediate layer, an alloy layer and an outer surface.

The intermediate layer of the present disclosure can be used to enhance the bonding strength between the substrate and the alloy layer. The intermediate layer can be disposed between the substrate and the alloy layer which can be composed of the metal oxide or the non-metallic oxide, such as an aluminum oxide, a silicon dioxide, a titanium dioxide, a zirconium dioxide, a magnesium oxide, a calcium oxide, a lithium oxide, a sodium oxide, a potassium oxide, a copper oxide and a zinc oxide, etc.

The alloy layer of the present disclosure can include at least three metals, at least four metals or at least five metals. In detail, the alloy layer can include a zirconium, a copper, an aluminum, a niobium, a nickel, a titanium, a beryllium, a magnesium, a calcium, a strontium, a scandium, a yttrium, a hafnium, a vanadium, a tantalum, a chromium, a molybdenum, a manganese, an iron, a cobalt, a palladium, a platinum, a silver, a gold, a gallium, a indium, a germanium, a tin, an antimony, a bismuth and a polonium. The weight percentage of the zirconium in the alloy layer can be 58%, 65%, 66%, 67%, 68%, 70%, 75% or 76%. The weight percentage of the copper in the alloy layer can be 10%, 14%, 18%, 20%, 22% or 28%. The weight percentage of the aluminum in the alloy layer can be 2%, 3%, 3.5%, 4%, 5%, 5.5% or 6%. The aforementioned alloy layer can be the amorphous alloy. The alloy is a mixture of at least two elementary substances and one of the at least two elementary substances is a metal. The amorphous alloy refers to alloys with an amorphous structure in a disordered state.

The outer surface of the present disclosure can be used to protect the alloy layer. The outer surface can be disposed on the air-facing side of the alloy layer which can be a metal coating or an anodic oxide layer. The metal coating can be a gold plating, a nickel plating, a chromium plating or a tin plating, etc. The anodic oxide layer can be a metal oxide, such as an aluminum oxide, a magnesium oxide or a titanium dioxide, etc.

The hardness of the present disclosure refers to Vickers hardness. The hardness is measured by a diamond with square pyramid and the face of the angle between the opposite face is 136°. The unit of the hardness is the Vickers hardness value (HV value).

The thickness of the substrate and the alloy layer of the present disclosure is determined by taking three points at any point on the same surface of the composite structure and drawing a vertical normal line. The vertical normal line should be pass through both the substrate and the alloy layer. The thickness along the vertical normal line is taken as the vertical thickness, and the vertical thickness at each of the three points is taken as the thickness of the substrate and the alloy layer.

The total length of the composite layer in the turning zone of the present disclosure refers to the maximum total length of the composite layer that can be obtained in each horizontal cross-section in the turning zone of the flat composite element.

The total length of the composite layer in the long edge area of the present disclosure refers to the maximum total length of the composite layer that can be obtained in each horizontal cross-section in the long edge area of the flat composite element.

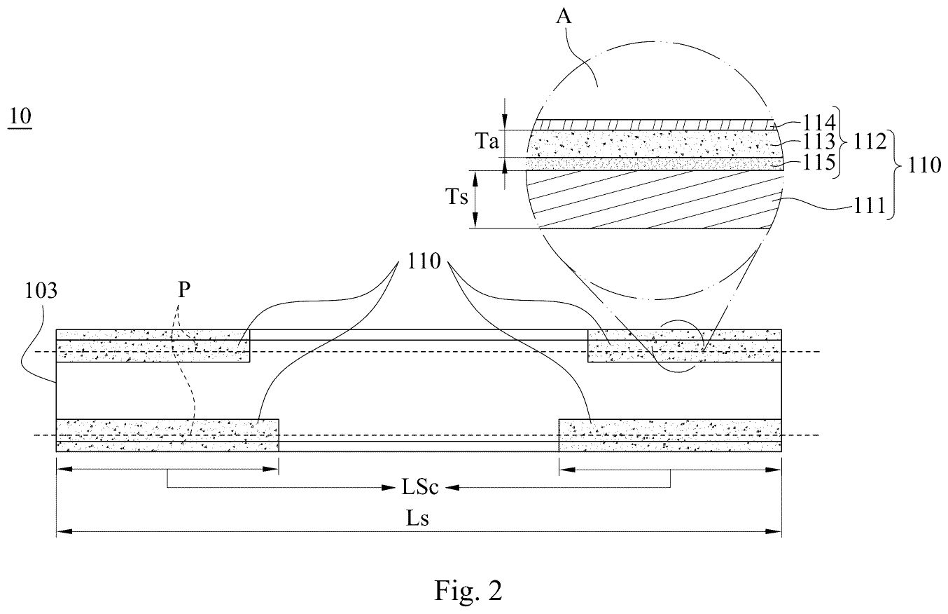

The total length of the composite layer in the short edge area of the present disclosure refers to the maximum total length of the composite layer that can be obtained in each horizontal cross-section in the short edge area of the flat composite element. As shown in FIG. 2, the composite structure 110 has the total length of the multiple composite layers 112 in the short edge area 103. However, the horizontal cross-section P should be used as the criterion for judgment. Choose the maximum value from the total length of the composite layer 112 corresponding to the two horizontal cross-sections P in FIG. 2, and use thereto as the total length in the short edge area 103 of the composite layer 112.

The horizontal cross-section of the present disclosure refers to a virtual plane that is parallel to the horizontal plane and intersects with the composite element.

The area of the composite layer in the composite element of the present disclosure refers to a single surface of the composite element, the projected area of the composite layer on the single surface.

The area of the substrate in the composite element of the present disclosure refers to a single surface of the composite element, the projected area of the substrate on the single surface.

The projected area of the present disclosure refers to an area of the surface projected on to the horizontal plane, the projected area can be used to standardize the calculation of the three-dimensional area of each surface.

Unless otherwise specified, the measurement environment in the present disclosure is taken at a room temperature of 25° C. and a humidity of 50%.

The technical features of the composite element of the present disclosure can be combined and configured to achieve the corresponding effects.

According to one embodiment of another aspect of the present disclosure, a mobile device includes the composite element according to the aforementioned aspect, the mobile device is a cell phone or a tablet computer.

According to another embodiment of another aspect of the present disclosure, a mobile device includes the composite element according to the aforementioned aspect.

The mobile device of the present disclosure can be a camera, a camcorder, a video camera, a cell phone, a tablet computer, a laptop, a mobile gaming device, a watch, a bracelet, augmented reality glasses, virtual reality glasses, an augmented reality headset and a virtual reality headset, etc.

### Example 1

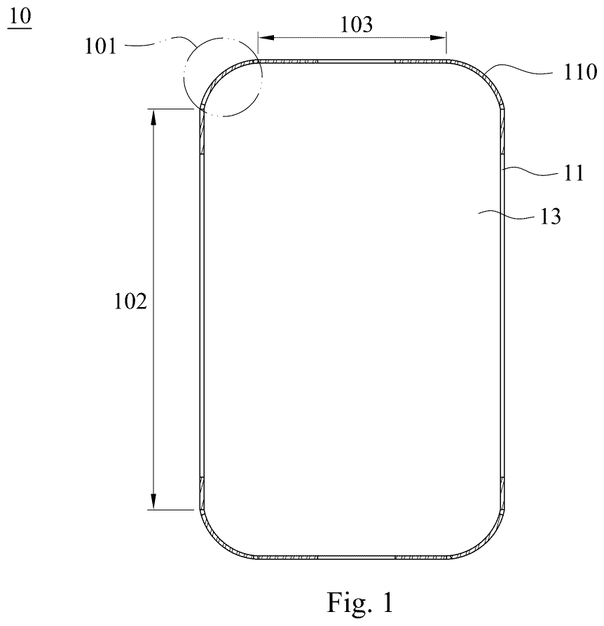

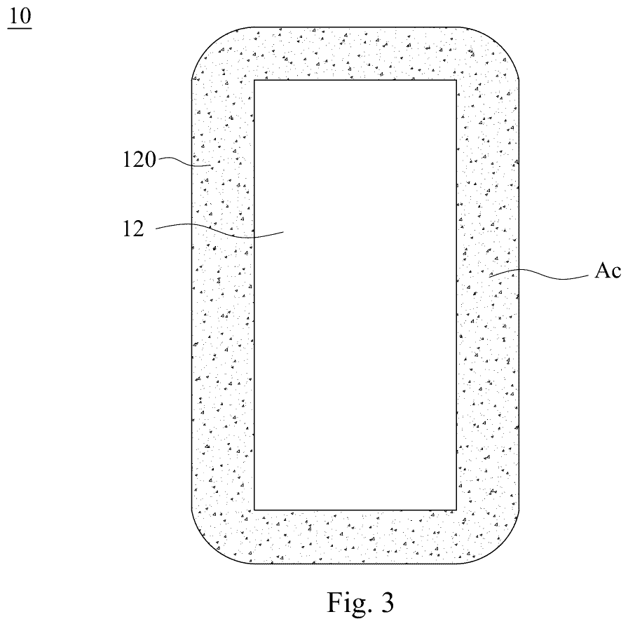

Please refer to FIG. 1, FIG. 2, FIG. 3, wherein FIG. 1 is a schematic view of a front side of the mobile device 10 according to the Example 1 of the present disclosure, FIG. 2 is a schematic view of the composite element of the mobile device 10 in FIG. 1 observed from the short edge area 103, FIG. 3 is a schematic view of a back side of the mobile device 10 in FIG. 1. The mobile device 10 of Example 1 can be a cell phone, and the mobile device 10 includes a composite element 11, a composite element 12 and a screen 13.

In the Example 1, the composite element 11 is a middle frame of the cell phone, the composite element 12 is a back panel of the cell phone, and the composite element 11 is connected between the screen 13 and the composite element 12.

As shown in FIG. 1 and FIG. 2, the composite element 11 has a turning zone 101, a long edge area 102 and a short edge area 103, and the composite element 11 includes a composite structure 110. The composite structure 110 includes a substrate 111 and a composite layer 112, and the composite layer 112 is disposed on a surface of the substrate 111. The composite layer 112 includes an alloy layer 113, an outer surface 114 and an intermediate layer 115. The alloy layer 113 is between the outer surface 114 and the intermediate layer 115. The outer surface 114 is disposed on the air-facing side of the alloy layer 113 near air A, while the intermediate layer 115 is disposed between the alloy layer 113 and the substrate 111.

Please refer to Table 1A, which shows the compositions of the alloy layer 113 and the proportions thereof in Example 1. In Example 1, the alloy layer 113 is an amorphous alloy, the alloy layer 113 includes at least three metals, and the at least three metals include a zirconium, a copper, an aluminum and a niobium.

TABLE 1A

| | Amorphous |
|---|---|
| Structure of alloy layer | alloy |
| Composition | Zirconium |
| | Copper |
| | Aluminum |
| | Niobium |
| Pzr (%) | 70 |
| Pcu (%) | 24 |
| Pal (%) | 4 |
| Weight percentage | 2 |
| of niobium in | |
| alloy layer (%) | |
| Pzr + Pcu + Pal (%) | 98 |

As shown in Table 1A, a weight percentage of the zirconium in the alloy layer 113 is Pzr, a weight percentage of the copper in the alloy layer 113 is Pcu, a weight percentage of the aluminum in the alloy layer 113 is Pal, and in Example 1, a total weight percentage of the zirconium, the copper, the aluminum in the alloy layer 113 is 98%.

Please refer to Table 1B, which shows the parameter details of the composite element 11 of Example 1, wherein a density of the alloy layer 113 is Da, a hardness of the alloy layer 113 is Ha, a coefficient of thermal conductivity of the alloy layer 113 is TCa, a thickness of the alloy layer 113 is Ta, a density of the substrate 111 is Ds, a hardness of the substrate 111 is Hs, the coefficient of thermal conductivity of the substrate 111 is TCs, a thickness of the substrate 111 is Ts, a total length of the composite layer 112 in the turning zone 101 is LCc, a total length of the composite layer 112 in the long edge area 102 is LLc, a total length of the composite layer 112 in the short edge area 103 is LSc, a length of the turning zone 101 is Lc, a length of the long edge area 102 is LI, and a length of the short edge area 103 is Ls.

TABLE 1B

| | | | |
|---|---|---|---|
| Da (g/cm³) | 6.68 | Ts (mm) | 2.5 |
| Ha (HV) | 480 | LCc (mm) | 10.00 |
| TCa (W/mK) | 2.5 | LLc (mm) | 20.00 |
| Ta (mm) | 0.70 | LSc (mm) | 35.75 |
| Material of | Aluminum | Lc (mm) | 11.74 |
| substrate | alloy | | |
| Ds (g/cm³) | 2.82 | Ll (mm) | 134.64 |
| Hs (HV) | 68 | Ls (mm) | 56.54 |
| TCs (W/mK) | 125 | | |

Parameter calculation

| | | | |
|---|---|---|---|
| Da/Ds | 2.37 | LCc/Lc | 0.85 |
| Ha/Hs | 7.06 | LLc/Ll | 0.15 |
| TCs/TCa | 50.00 | LSc/Ls | 0.63 |
| Ta/Ts | 0.28 | | |

In Example 1, a material of the substrate 111 is an aluminum alloy, a total length of the composite layer 112 in the turning zone 101 is 10.00 mm, a total length of the composite layer 112 in the long edge area 102 is 20.00 mm, a total length of the composite layer 112 in the short edge area 103 is 35.75 mm, a length of the turning zone 101 is 11.74 mm, a length of the long edge area 102 is 134.64 mm and a length of the short edge area 103 is 56.54 mm. Furthermore, because of the composite structure 110 has a total length of the multiple composite layers 112 on the short edge area 103, the horizontal cross-section P is used as the criterion, and the maximum value is selected from the total length of the composite layer 112 corresponding to the two horizontal cross-sections P is selected as the total length LSc of the composite layer 112 in the short edge area 103.

As shown in FIG. 3, the composite element 12 includes a composite structure 120, the composite structure 120 includes a substrate (not shown in Figure) and a composite layer (not shown in Figure), and the composite layer is disposed on a surface of the substrate, wherein a material of the substrate is a glass and the composite layer includes the alloy layer. Furthermore, the composite layer of the composite structure 120 of the composite element 12 and the parameter details of the alloy layer are the same as the composite layer 112 of the composite structure 110 of the composite element 11 and the alloy layer 113, so that the same details are shown in the aforementioned paragraphs and will not be described again herein.

Please refer to Table 1C, which shows the parameter details of the composite element 12 of Example 1, wherein an area of the composite layer in the composite element 12 is Ac, and an area of the substrate in the composite element 12 is As.

TABLE 1C

| | |
|---|---|
| Ac (mm²) | 4200.00 |
| As (mm²) | 10578.02 |
| Ac/As | 0.397 |

Furthermore, a size of the mobile device 10 of FIG. 1 to FIG. 3 is for illustrative purpose only, actual values for each parameter are based on the values listed in Table 1A to Table 1C. Besides, if the definitions of the data in the tables of the following embodiments are the same as the Table 1A to Table 1C and will not be described again herein.

### Example 2

A mobile device of Example 2 can be a cell phone, and the mobile device includes a first composite element and a second composite element, wherein the first composite element is a middle frame of the cell phone, and the second composite element is a back panel of the cell phone.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum and a niobium.

Please refer to Table 2A, which shows the compositions of the alloy layer of the first composite element and the proportions thereof in Example 2.

TABLE 2A

| | Amorphous |
|---|---|
| Structure of alloy layer | alloy |
| Composition | Zirconium |
| | Copper |
| | Aluminum |
| | Niobium |
| Pzr (%) | 70 |
| Pcu (%) | 24 |
| Pal (%) | 4 |
| Weight percentage | 2 |
| of niobium in | |
| alloy layer (%) | |
| Pzr + Pcu + Pal (%) | 98 |

In Example 2, a total weight percentage of the zirconium, the copper, and the aluminum in the alloy layer of the first composite element is 98%.

Please refer to Table 2B, which shows the parameter details of the first composite element of Example 2.

TABLE 2B

| | | | |
|---|---|---|---|
| Da (g/cm³) | 6.68 | Ts (mm) | 2.0 |
| Ha (HV) | 480 | LCc (mm) | 11.00 |
| TCa (W/mK) | 2.5 | LLc (mm) | 20.00 |
| Ta (mm) | 0.65 | LSc (mm) | 38.80 |
| Material of | Aluminum | Lc (mm) | 12.80 |
| substrate | alloy | | |
| Ds (g/cm³) | 2.81 | Ll (mm) | 146.70 |
| Hs (HV) | 162 | Ls (mm) | 61.30 |
| TCs (W/mK) | 163 | | |

Parameter calculation

| | | | |
|---|---|---|---|
| Da/Ds | 2.38 | LCc/Lc | 0.86 |
| Ha/Hs | 2.96 | LLc/Ll | 0.14 |
| TCs/TCa | 65.20 | LSc/Ls | 0.63 |
| Ta/Ts | 0.33 | | |

In Example 2, a material of the substrate of the first composite element is an aluminum alloy. A total length of the composite layer in the turning zone is 11.00 mm. A total length of the composite layer in the long edge area is 20.00 mm. A total length of the composite layer in the short edge area is 38.80 mm. A length of the turning zone is 12.80 mm. A length of the long edge area is 146.70 mm. A length of the short edge area is 61.30 mm.

The second composite element includes a composite structure, the composite structure includes a substrate and a composite layer, and the composite layer is disposed on a surface of the substrate, wherein a material of the substrate is a plastic, and the composite layer includes an alloy layer. Furthermore, the parameter details of the composite layer and the alloy layer of the composite structure of the second composite element of Example 2 can be the same as the parameter details of the composite layer and the alloy layer of the composite structure of the first composite element, so that the same details are shown in the aforementioned paragraphs and will not be described again herein.

Please refer to Table 2C, which shows the parameter details of the second composite element of Example 2.

TABLE 2C

| | |
|---|---|
| Ac (mm²) | 5000.00 |
| As (mm²) | 12508.26 |
| Ac/As | 0.400 |

### Example 3

A mobile device of Example 3 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum and a niobium.

Please refer to Table 3A, which shows the compositions of the alloy layer of the first composite element and the proportions thereof in Example 3.

TABLE 3A

| Structure of alloy layer | Amorphous alloy |
|---|---|
| Composition | Zirconium |
| | Copper |
| | Aluminum |
| | Niobium |
| Pzr (%) | 70 |
| Pcu (%) | 24 |
| Pal (%) | 4 |
| Weight percentage of niobium in alloy layer (%) | 2 |
| Pzr + Pcu + Pal (%) | 98 |

In Example 3, a total weight percentage of the zirconium, the copper, and the aluminum in the alloy layer of the first composite element is 98%.

Please refer to Table 3B3, which shows the parameter details of the first composite element of Example 3.

TABLE 3B

| | | | |
|---|---|---|---|
| Da (g/cm³) | 6.68 | Ts (mm) | 1.5 |
| Ha (HV) | 480 | LCc (mm) | 12.00 |
| TCa (W/mK) | 2.5 | LLc (mm) | 15.00 |
| Ta (mm) | 1.20 | LSc (mm) | 8.00 |
| Material of substrate | Aluminum alloy | Lc (mm) | 15.34 |
| Ds (g/cm³) | 2.69 | Ll (mm) | 175.86 |
| Hs (HV) | 83 | Ls (mm) | 115.26 |
| TCs (W/mK) | 200 | | |

Parameter calculation

| | | | |
|---|---|---|---|
| Da/Ds | 2.48 | LCc/Lc | 0.78 |
| Ha/Hs | 5.78 | LLc/Ll | 0.09 |
| TCs/TCa | 80.00 | LSc/Ls | 0.07 |
| Ta/Ts | 0.80 | | |

In Example 3, a material of the substrate of the first composite element is an aluminum alloy. A total length of the composite layer in the turning zone is 12.00 mm. A total length of the composite layer in the long edge area is 15.00 mm. A total length of the composite layer in the short edge area is 8.00 mm. A length of the turning zone is 15.34 mm. A length of the long edge area is 175.86 mm. A length of the short edge area is 115.26 mm.

The second composite element includes a composite structure, the composite structure includes a substrate and a composite layer, and the composite layer is disposed on a surface of the substrate, wherein a material of the substrate is an aluminum alloy, and the composite layer includes an alloy layer. Furthermore, the parameter details of the composite layer and the alloy layer of the composite structure of the second composite element of Example 3 can be the same as the parameter details of the composite layer and the alloy layer of the composite structure of the first composite element, so that the same details are shown in the aforementioned paragraphs and will not be described again herein.

Please refer to Table 3C, which shows the parameter details of the second composite element of Example 3.

TABLE 3C

| | | | |
|---|---|---|---|
| Ac (mm²) | 10000.00 | Ac/As | 0.383 |
| As (mm²) | 26137.95 | | |

### Example 4

A mobile device of Example 4 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum and a niobium.

Please refer to Table 4A, which shows the compositions of the alloy layer of the first composite element and the proportions thereof in Example 4.

TABLE 4A

| Structure of alloy layer | Amorphous alloy |
|---|---|
| Composition | Zirconium |
| | Copper |
| | Aluminum |
| | Niobium |
| Pzr (%) | 70 |
| Pcu (%) | 24 |
| Pal (%) | 4 |
| Weight percentage of niobium in alloy layer (%) | 2 |
| Pzr + Pcu + Pal (%) | 98 |

In Example 4, a total weight percentage of the zirconium, the copper, and the aluminum in the alloy layer of the first composite element is 98%.

Please refer to Table 4B, which shows the parameter details of the first composite element of Example 4.

TABLE 4B

| | | | |
|---|---|---|---|
| Da (g/cm³) | 6.68 | Ts (mm) | 1.0 |
| Ha (HV) | 480 | LCc (mm) | 19.52 |
| TCa (W/mK) | 2.5 | LLc (mm) | 20.00 |
| Ta (mm) | 1.00 | LSc (mm) | 8.00 |
| Material of substrate | Titanium alloy | Lc (mm) | 19.52 |
| Ds (g/cm³) | 4.51 | Ll (mm) | 223.74 |
| Hs (HV) | 350 | Ls (mm) | 154.64 |
| TCs (W/mK) | 15.24 | | |

Parameter calculation

| | | | |
|---|---|---|---|
| Da/Ds | 1.48 | LCc/Lc | 1.00 |
| Ha/Hs | 1.37 | LLc/Ll | 0.09 |
| TCs/TCa | 6.10 | LSc/Ls | 0.05 |
| Ta/Ts | 1.00 | | |

In Example 4, a material of the first composite element is a titanium alloy. A total length of composite layer in the turning zone is 19.52 mm. A total length of the composite layer in the long edge area is 20.00 mm. A total length of the composite layer in the short edge area is 8.00 mm. A length of the turning zone is 19.52 mm. A length of the long edge area is 223.74 mm. A length of the short edge area is 154.64 mm.

The second composite element includes a composite structure, the composite structure includes a substrate and a composite layer, and the composite layer is disposed on a surface of the substrate, wherein a material of the substrate is a titanium alloy, and the composite layer includes an alloy layer. Furthermore, the parameter details of the composite layer and the alloy layer of the composite structure of the second composite element of Example 4 can be the same as the parameter details of the composite layer and the alloy layer of the composite structure of the first composite element, so that the same details are shown in the aforementioned paragraphs and will not be described again herein.

Please refer to Table 4C, which shows the parameter details of the second composite element of Example 4.

TABLE 4C

| | | | |
|---|---|---|---|
| Ac (mm²) | 15000.00 | Ac/As | 0.339 |
| As (mm²) | 44296.78 | | |

### Example 5

A mobile device of Example 5 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum and a niobium.

Please refer to Table 5A, which shows the compositions of the alloy layer of the first composite element and the proportions thereof in Example 5.

TABLE 5A

| Structure of alloy layer | Amorphous alloy |
|---|---|
| Composition | Zirconium |
| | Copper |
| | Aluminum |
| | Niobium |
| Pzr (%) | 70 |
| Pcu (%) | 24 |
| Pal (%) | 4 |
| Weight percentage of niobium in alloy layer (%) | 2 |
| Pzr + Pcu + Pal (%) | 98 |

In Example 5, a total weight percentage of the zirconium, the copper, and the aluminum in the alloy layer of the first composite element is 98%.

Please refer to Table 51B, which shows the parameter details of the first composite element of Example 5.

TABLE 5B

| | | | |
|---|---|---|---|
| Da (g/cm³) | 6.68 | Ts (mm) | 0.5 |
| Ha (HV) | 480 | LCc (mm) | 19.60 |
| TCa (W/mK) | 2.5 | LLc (mm) | 20.00 |
| Ta (mm) | 0.50 | LSc (mm) | 8.00 |
| Material of substrate | Titanium alloy | Lc (mm) | 19.60 |
| Ds (g/cm³) | 4.51 | Ll (mm) | 224.73 |
| Hs (HV) | 350 | Ls (mm) | 152.53 |
| TCs (W/mK) | 15.24 | | |

Parameter calculation

| | | | |
|---|---|---|---|
| Da/Ds | 1.48 | LCc/Lc | 1.00 |
| Ha/Hs | 1.37 | LLc/Ll | 0.09 |
| TCs/TCa | 6.10 | LSc/Ls | 0.05 |
| Ta/Ts | 1.00 | | |

In Example 5, a material of the first composite element is a titanium alloy. A total length of composite layer in the turning zone is 19.60 mm. A total length of the composite layer in the long edge area is 20.00 mm. A total length of the composite layer in the short edge area is 8.00 mm. A length of the turning zone is 19.60 mm. A length of the long edge area is 224.73 mm. A length of the short edge area is 152.53 mm.

The second composite element includes a composite structure, the composite structure includes a substrate and a composite layer, and the composite layer is disposed on a surface of the substrate, wherein a material of the substrate is a glass, and the composite layer includes an alloy layer. Furthermore, the parameter details of the composite layer and the alloy layer of the composite structure of the second composite element of Example 5 can be the same as the parameter details of the composite layer and the alloy layer of the composite structure of the first composite element, so that the same details are shown in the aforementioned paragraphs and will not be described again herein.

Please refer to Table 5C, which shows the parameter details of the second composite element of Example 5.

TABLE 5C

| | | | |
|---|---|---|---|
| Ac (mm²) | 19000.00 | Ac/As | 0.432 |
| As (mm²) | 43991.94 | | |

### Example 6

A mobile device of Example 6 can be a watch, and the mobile device includes a first composite element and a second composite element. In Example 6, the first composite element is a middle frame of the watch, and the second composite element is a front frame of the watch.

The first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum and a niobium.

Please refer to Table 6A, which shows the compositions of the alloy layer of the first composite element and the proportions thereof in Example 6.

TABLE 6A

| Structure of alloy layer | Amorphous alloy |
|---|---|
| Composition | Zirconium |
| | Copper |
| | Aluminum |
| | Niobium |
| Pzr (%) | 70 |
| Pcu (%) | 24 |
| Pal (%) | 4 |
| Weight percentage of niobium in alloy layer (%) | 2 |
| Pzr + Pcu + Pal (%) | 98 |

In Example 6, a total weight percentage of the zirconium, the copper, and the aluminum in the alloy layer of the first composite element is 98%.

Please refer to Table 6B, which shows the parameter details of the first composite element of Example 6, wherein a material of the first composite element is a titanium alloy.

TABLE 6B

| | | | |
|---|---|---|---|
| Da (g/cm³) | 6.68 | Ds (g/cm³) | 4.51 |
| Ha (HV) | 480 | Hs (HV) | 155 |
| TCa (W/mK) | 2.5 | TCs (W/mK) | 15.24 |
| Ta (mm) | 0.75 | Ts (mm) | 0.8 |

Parameter calculation

| | | | |
|---|---|---|---|
| Da/Ds | 1.48 | TCs/TCa | 6.10 |
| Ha/Hs | 3.10 | Ta/Ts | 0.94 |

The second composite element includes a composite structure, the composite structure includes a substrate and a composite layer, and the composite layer is disposed on a surface of the substrate, wherein a material of the substrate is a titanium alloy, and the composite layer includes an alloy layer. Furthermore, the parameter details of the alloy layer of the composite structure of the second composite element of Example 6 can be the same as the parameter details of the alloy layer of the composite structure of the first composite element, so that the same details are shown in the aforementioned paragraphs and will not be described again herein.

Please refer to Table 6C, which shows the parameter details of the second composite element of Example 6.

TABLE 6C

| | | | |
|---|---|---|---|
| Ac (mm²) | 28.15 | Ac/As | 0.018 |
| As (mm²) | 1590.43 | | |

### Example 7

A mobile device of Example 7 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 7A, which shows the compositions of the alloy layer of the first composite element and the proportions thereof in Example 7.

TABLE 7A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 7, a total weight percentage of the zirconium, the copper, and the aluminum in the alloy layer of the first composite element is 85%.

Please refer to Table 7B, which shows the parameter details of the first composite element of Example 7.

TABLE 7B

| | | | |
|---|---|---|---|
| Da (g/cm³) | 6.65 | Ts (mm) | 1.0 |
| Ha (HV) | 540 | LCc (mm) | 21.00 |
| TCa (W/mK) | 2.5 | LLc (mm) | 30.00 |
| Ta (mm) | 0.85 | LSc (mm) | 15.00 |
| Material of substrate | Stainless steel | Lc (mm) | 22.11 |
| Ds (g/cm³) | 7.93 | Ll (mm) | 253.44 |
| Hs (HV) | 200 | Ls (mm) | 187.34 |
| TCs (W/mK) | 15 | | |

Parameter calculation

| | | | |
|---|---|---|---|
| Da/Ds | 0.84 | LCc/Lc | 0.95 |
| Ha/Hs | 2.70 | LLc/Ll | 0.12 |
| TCs/TCa | 6.00 | LSc/Ls | 0.08 |
| Ta/Ts | 0.85 | | |

In Example 7, a material of the first composite element is a stainless steel. A total length of composite layer in the turning zone is 21.00 mm. A total length of the composite layer in the long edge area is 30.00 mm. A total length of the composite layer in the short edge area is 15.00 mm. A length of the turning zone is 22.11 mm. A length of the long edge area is 253.44 mm. A length of the short edge area is 187.34 mm.

The second composite element includes a composite structure, the composite structure includes a substrate and a composite layer, and the composite layer is disposed on a surface of the substrate, wherein a material of the substrate is a plastic, and the composite layer includes an alloy layer. Furthermore, the parameter details of the alloy layer of the composite structure of the second composite element of Example 7 can be the same as the parameter details of the alloy layer of the composite structure of the first composite element, so that the same details are shown in the aforementioned paragraphs and will not be described again herein.

Please refer to Table 7C, which shows the parameter details of the second composite element of Example 7.

TABLE 7C

| | | | |
|---|---|---|---|
| Ac (mm²) | 25000.00 | Ac/As | 0.415 |
| As (mm²) | 60265.33 | | |

### Example 8

A mobile device of Example 8 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 8A, which shows the compositions of the alloy layer of the first composite element and the proportions thereof in Example 8.

TABLE 8A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 8, a total weight percentage of the zirconium, the copper, and the aluminum in the alloy layer of the first composite element is 85%.

Please refer to Table 8B, which shows the parameter details of the first composite element of Example 8.

TABLE 8B

| | | | |
|---|---|---|---|
| Da (g/cm³) | 6.65 | Ts (mm) | 1.2 |
| Ha (HV) | 540 | LCc (mm) | 21.50 |
| TCa (W/mK) | 2.5 | LLc (mm) | 30.00 |
| Ta (mm) | 0.95 | LSc (mm) | 18.00 |
| Material of substrate | Stainless steel | Lc (mm) | 22.40 |
| Ds (g/cm³) | 7.93 | Ll (mm) | 256.86 |
| Hs (HV) | 200 | Ls (mm) | 156.86 |
| TCs (W/mK) | 15 | | |

Parameter calculation

| | | | |
|---|---|---|---|
| Da/Ds | 0.84 | LCc/Lc | 0.96 |
| Ha/Hs | 2.70 | LLc/Ll | 0.12 |
| TCs/TCa | 6.00 | LSc/Ls | 0.11 |
| Ta/Ts | 0.79 | | |

In Example 8, a material of the first composite element is a stainless steel. A total length of composite layer in the turning zone is 21.50 mm. A total length of the composite layer in the long edge area is 30.00 mm. A total length of the composite layer in the short edge area is 18.00 mm. A length of the turning zone is 22.40 mm. A length of the long edge area is 256.86 mm. A length of the short edge area is 156.86 mm.

The second composite element includes a composite structure, the composite structure includes a substrate and a composite layer, and the composite layer is disposed on a surface of the substrate, wherein a material of the substrate is an aluminum alloy, and the composite layer includes an alloy layer. Furthermore, the parameter details of the alloy layer of the composite structure of the second composite element of Example 8 can be the same as the parameter details of the alloy layer of the composite structure of the first composite element, so that the same details are shown in the aforementioned paragraphs and will not be described again herein.

Please refer to Table 8C, which shows the parameter details of the second composite element of Example 8.

TABLE 8C

| | | | |
|---|---|---|---|
| Ac (mm²) | 23000.00 | Ac/As | 0.438 |
| As (mm²) | 52482.30 | | |

### Example 9

A mobile device of Example 9 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 9A, which shows the compositions of the alloy layer of the first composite element and the proportions thereof in Example 9.

TABLE 9A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 9, a total weight percentage of the zirconium, the copper, and the aluminum in the alloy layer of the first composite element is 85%.

Please refer to Table 9B, which shows the parameter details of the first composite element of Example 9.

TABLE 9B

| | | | |
|---|---|---|---|
| Da (g/cm³) | 6.65 | Ts (mm) | 1.2 |
| Ha (HV) | 540 | LCc (mm) | 25.62 |
| TCa (W/mK) | 2.5 | LLc (mm) | 28.00 |
| Ta (mm) | 1.05 | LSc (mm) | 20.00 |
| Material of substrate | Aluminum alloy | Lc (mm) | 25.62 |
| Ds (g/cm³) | 2.82 | Ll (mm) | 293.76 |
| Hs (HV) | 68 | Ls (mm) | 175.96 |
| TCs (W/mK) | 125 | | |

Parameter calculation

| | | | |
|---|---|---|---|
| Da/Ds | 2.36 | LCc/Lc | 1.00 |
| Ha/Hs | 7.94 | LLc/Ll | 0.10 |
| TCs/TCa | 50.00 | LSc/Ls | 0.11 |
| Ta/Ts | 0.88 | | |

In Example 9, a material of the first composite element is an aluminum alloy. A total length of composite layer in the turning zone is 25.62 mm. A total length of the long edge area in the composite layer is 28.00 mm. A total length of the short edge area in the composite layer is 20.00 mm. A length of the turning zone is 25.62 mm. A length of the long edge area is 293.76 mm. A length of the short edge area is 175.96 mm.

The second composite element includes a composite structure, the composite structure includes a substrate and a composite layer, and the composite layer is disposed on a surface of the substrate, wherein a material of the substrate is the titanium alloy, and the composite layer includes the alloy layer. Furthermore, the parameter details of the composite layer and the alloy layer of the composite structure of the second composite element of Example 9 can be the same as the parameter details of the composite layer and the alloy layer of the composite structure of the first composite element, so that the same details are shown in the aforementioned paragraphs and will not be described again herein.

Please refer to Table 9C, which shows the parameter details of the second composite element of Example 9.

TABLE 9C

| | | | |
|---|---|---|---|
| Ac (mm²) | 34000.00 | Ac/As | 0.504 |
| As (mm²) | 67523.49 | | |

### Example 10

A mobile device of Example 10 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 10A, which shows the compositions of the alloy layer of the first composite element and the proportions thereof in Example 10.

TABLE 10A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 10, a total weight percentage of the zirconium, the copper, and the aluminum in the alloy layer of the first composite element is 85%.

Please refer to Table 10B, which shows the parameter details of the first composite element of Example 10.

TABLE 10B

| | | | |
|---|---|---|---|
| Da (g/cm³) | 6.65 | Ts (mm) | 1.8 |
| Ha (HV) | 540 | LCc (mm) | 19.00 |
| TCa (W/mK) | 2.5 | LLc (mm) | 30.00 |
| Ta (mm) | 1.10 | LSc (mm) | 20.00 |
| Material of substrate | Aluminum alloy | Lc (mm) | 19.94 |
| Ds (g/cm³) | 2.81 | Ll (mm) | 228.56 |
| Hs (HV) | 162 | Ls (mm) | 139.79 |
| TCs (W/mK) | 163 | | |

Parameter calculation

| | | | |
|---|---|---|---|
| Da/Ds | 2.37 | LCc/Lc | 0.95 |
| Ha/Hs | 3.33 | LLc/Ll | 0.13 |
| TCs/TCa | 65.20 | LSc/Ls | 0.14 |
| Ta/Ts | 0.61 | | |

In Example 10, a material of the substrate of the first composite element is an aluminum alloy. A total length of composite layer in the turning zone is 19.00 mm. A total length of the composite layer in the long edge area is 30.00 mm. A total length of the composite layer in the short edge area is 20.00 mm. A length of the turning zone is 19.94 mm. A length of the long edge area is 228.56 mm. A length of the short edge area is 139.79 mm.

The second composite element includes a composite structure, the composite structure includes a substrate and a composite layer, and the composite layer is disposed on a surface of the substrate, wherein a material of the substrate is a glass, and the composite layer includes an alloy layer. Furthermore, the parameter details of the composite layer and the alloy layer of the composite structure of the second composite element of Example 10 can be the same as the parameter details of the composite layer and the alloy layer of the composite structure of the first composite element, so that the same details are shown in the aforementioned paragraphs and will not be described again herein.

Please refer to Table 10C, which shows the parameter details of the second composite element of Example 10.

TABLE 10C

| | | | |
|---|---|---|---|
| Ac (mm²) | 22000.00 | Ac/As | 0.529 |
| As (mm²) | 41606.32 | | |

### Example 11

A mobile device of Example 11 can be a tablet computer, and the mobile device includes a first composite element and a second composite element, wherein the first composite element is a middle frame of the tablet computer, and the second composite element is a back panel of the tablet computer.

The first composite element has a turning zone, a long edge area and a short edge area, and the first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 11A, which shows the compositions of the alloy layer of the first composite element and the proportions thereof in Example 11.

TABLE 11A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 11, a total weight percentage of the zirconium, the copper, and the aluminum in the alloy layer of the first composite element is 85%.

Please refer to Table 11B, which shows the parameter details of the first composite element of Example 11.

TABLE 11B

| | | | |
|---|---|---|---|
| Da (g/cm³) | 6.65 | Ts (mm) | 1.3 |
| Ha (HV) | 540 | LCc (mm) | 25.01 |
| TCa (W/mK) | 2.5 | LLc (mm) | 10.00 |
| Ta (mm) | 1.15 | LSc (mm) | 5.00 |
| Material of substrate | Aluminum alloy | Lc (mm) | 25.01 |
| Ds (g/cm³) | 2.69 | Ll (mm) | 286.72 |
| Hs (HV) | 83 | Ls (mm) | 174.24 |
| TCs (W/mK) | 200 | | |

Parameter calculation

| | | | |
|---|---|---|---|
| Da/Ds | 2.47 | LCc/Lc | 1.00 |
| Ha/Hs | 6.51 | LLc/Ll | 0.03 |
| TCs/TCa | 80.00 | LSc/Ls | 0.03 |
| Ta/Ts | 0.88 | | |

In Example 11, a material of the first composite element is an aluminum alloy. A total length of composite layer in the turning zone is 25.01 mm. A total length of the composite layer in the long edge area is 10.00 mm. A total length of the composite layer in the short edge area is 5.00 mm. A length of the turning zone is 25.01 mm. A length of the long edge area is 286.72 mm. A length of the short edge area is 174.24 mm.

The second composite element includes a composite structure, the composite structure includes a substrate and a composite layer, and the composite layer is disposed on a surface of the substrate, wherein a material of the substrate is a plastic, and the composite layer includes an alloy layer. Furthermore, the parameter details of the alloy layer of the composite structure of the second composite element of Example 11 can be the same as the parameter details of the alloy layer of the composite structure of the first composite element, so that the same details are shown in the aforementioned paragraphs and will not be described again herein.

Please refer to Table 11C, which shows the parameter details of the second composite element of Example 11.

TABLE 11C

| | | | |
|---|---|---|---|
| Ac (mm²) | 35000.00 | Ac/As | 0.537 |
| As (mm²) | 65122.47 | | |

### Example 12

A mobile device of Example 12 can be a watch, and the mobile device includes a first composite element and a second composite element. In Example 12, the first composite element is a middle frame of the watch, and the second composite element is a front frame of the watch.

The first composite element includes a composite structure. The composite structure includes a substrate and a composite layer, and the composite layer is disposed on a surface of the substrate. The composite layer includes an alloy layer, the alloy layer is an amorphous alloy, wherein the alloy layer includes at least three metals, and the at least three metals include a zirconium, a copper, an aluminum, a nickel and a titanium.

Please refer to Table 12A, which shows the compositions of the alloy layer of the first composite element and the proportions thereof in Example 12.

TABLE 12A

| Structure of alloy layer | Amorphous alloy |
|---|---|
| Composition | Zirconium |
| | Copper |
| | Aluminum |
| | Nickel |
| | Titanium |
| Pzr (%) | 65 |
| Pcu (%) | 16 |
| Pal (%) | 4 |
| Weight percentage of nickel in alloy layer (%) | 12 |
| Weight percentage of titanium in alloy layer (%) | 3 |
| Pzr + Pcu + Pal (%) | 85 |

In Example 12, a total weight percentage of the zirconium, the copper, and the aluminum in the alloy layer of the first composite element is 85%.

Please refer to Table 12B, which shows the parameter details of the first composite element of Example 12, wherein a material of the first composite element is a titanium alloy.

TABLE 12B

| | | | |
|---|---|---|---|
| Da (g/cm³) | 6.65 | Ds (g/cm³) | 4.51 |
| Ha (HV) | 540 | Hs (HV) | 350 |
| TCa (W/mK) | 2.5 | TCs (W/mK) | 15.24 |
| Ta (mm) | 0.60 | Ts (mm) | 0.8 |

Parameter calculation

| | | | |
|---|---|---|---|
| Da/Ds | 1.47 | TCs/TCa | 6.10 |
| Ha/Hs | 1.54 | Ta/Ts | 0.75 |

The second composite element includes a composite structure, the composite structure includes a substrate and a composite layer, and the composite layer is disposed on a surface of the substrate, wherein a material of the substrate is a titanium alloy, and the composite layer includes an alloy layer. Furthermore, the parameter details of the alloy layer of the composite structure of the second composite element of Example 12 can be the same as the parameter details of the alloy layer of the composite structure of the first composite element, so that the same details are shown in the aforementioned paragraphs and will not be described again herein.

Please refer to Table 12C, which shows the parameter details of the second composite element of Example 12.

TABLE 12C

| | | | |
|---|---|---|---|
| Ac (mm²) | 79.33 | Ac/As | 0.039 |
| As (mm²) | 2042.82 | | |

### Example 13

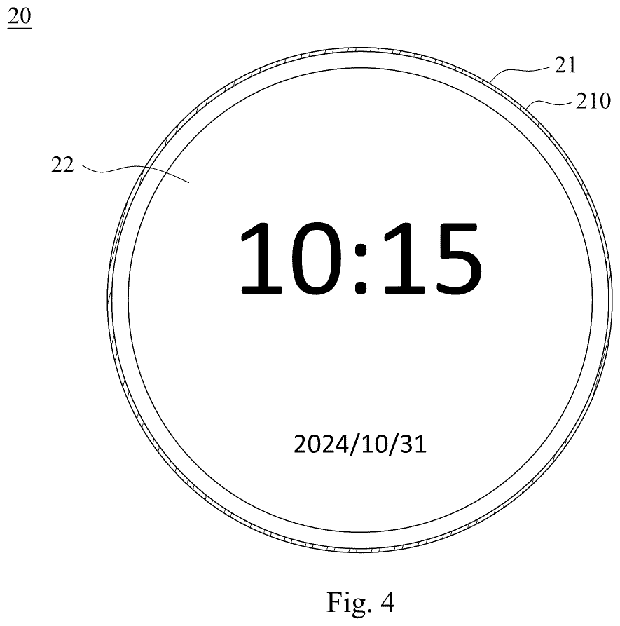

Please refer to FIG. 4, which is a schematic view of a front side of the mobile device 20 according to the Example 13 of the present disclosure.

A mobile device 20 of Example 13 is a watch, and the mobile device includes a composite element 21 and a surface 22, the composite element 21 is the middle frame of the watch, and the composite element 21 surrounds the peripheral surface of the surface 22. The composite element 21 includes a composite structure 210, the composite structure 210 includes a substrate (not shown in Figure) and a composite layer (not shown in Figure), and the composite layer is disposed on a surface of the substrate.

Furthermore, the mobile device 20 of Example 13 can be the same configuration sample as the mobile devices of the Example 6 and Example 12, so that the related details please refer to the descriptions of the Example 6 and Example 12 and will not be described again herein.

### Example 14

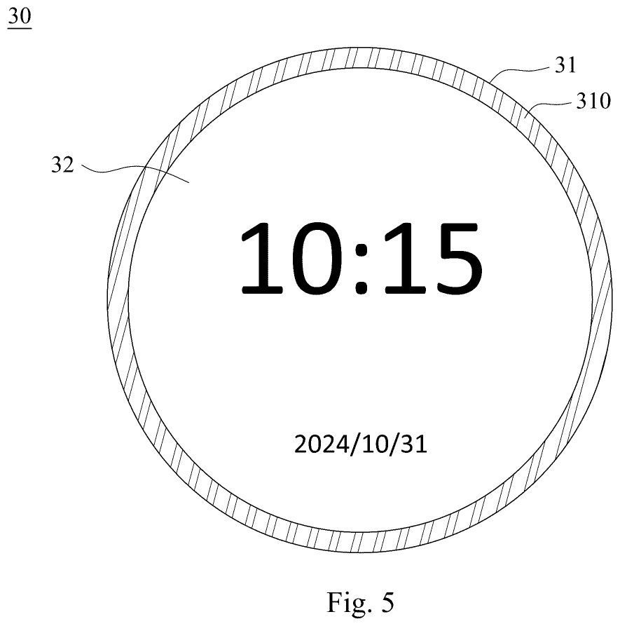

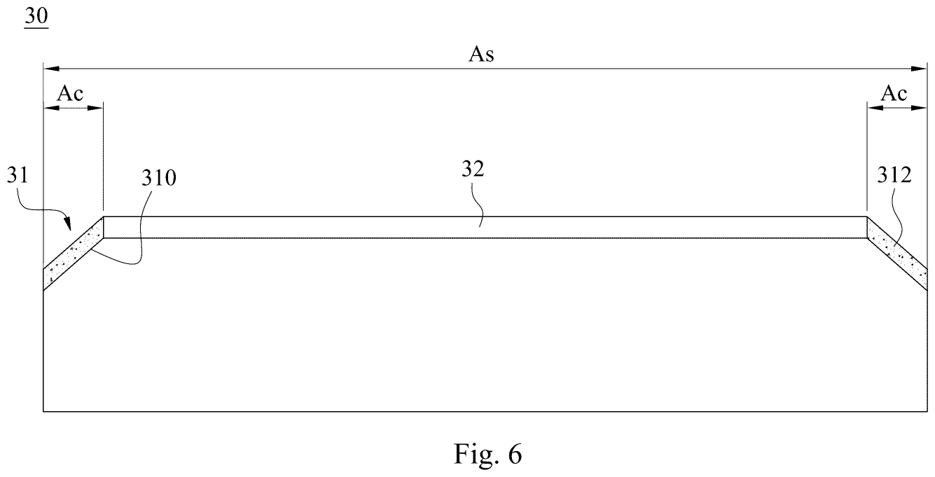

Please refer to FIG. 5 and FIG. 6, the FIG. 5 is a schematic view of a front side of the mobile device 30 according to the example 14 of the present disclosure, the FIG. 6 is a side view of the mobile device 30 in FIG. 5.

A mobile device of Example 14 is a watch, and the watch includes a composite element 31 and a surface 32, the composite element 31 is the front frame of the watch, and the composite element 31 surrounds the peripheral surface of the surface 32. The composite element 31 includes a composite structure 310, the composite structure 310 includes a substrate (not shown in Figure) and a composite layer 312, and the composite layer 312 is disposed on a surface of the substrate.

As shown in FIG. 6, an area Ac of the composite layer 312 on the composite element 31 refers to the area of the composite layer 312 projected onto a single surface of the composite element 31, while an area As of the substrate on the composite element 31 refers to the area of the substrate projected onto a single surface of the composite element 31.

Furthermore, the mobile device 30 of Example 14 can be the same configuration sample as the mobile devices of the Example 6 and Example 12, so that the related details please refer to the descriptions of the Example 6 and Example 12 and will not be described again herein.

### Example 15

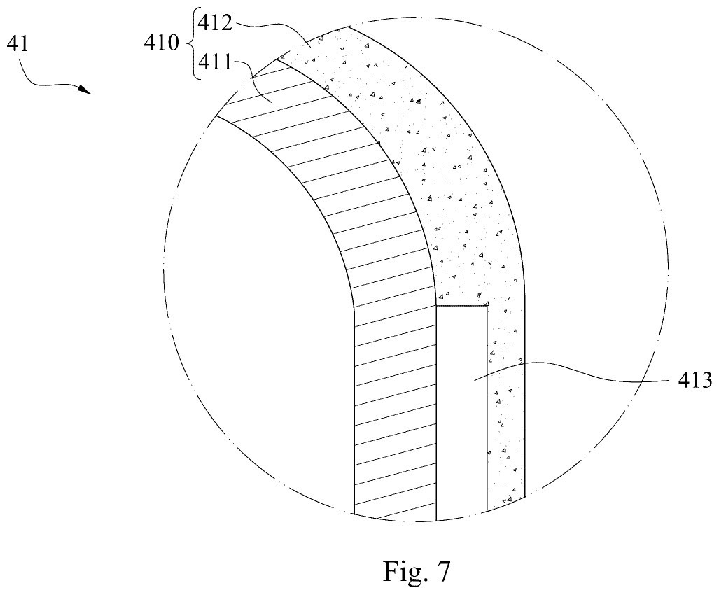

Please refer to FIG. 7, which is a schematic view of a part of the composite element 41 according to the Example 15 of the present disclosure. The composite element 41 includes a composite structure 410, the composite structure 410 includes a substrate 411 and a composite layer 412, and the composite layer 412 is disposed on a surface of the substrate 411.

In Example 15, the composite structure 410 further includes a buffering layer 413, the buffering layer 413 is located between the composite layer 412 and the substrate 411 to avoid direct damage to the lower hardness of the substrate 411 when the composite structure 410 is subjected to impact.

Furthermore, the composite element 41 of Example 15 can be applied to the mobile devices of Example 1 to Example 12, so that the related details please refer to the descriptions of the Example 1 to Example 12 and will not be described again herein.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A composite element, comprising:
a composite structure comprises a substrate and a composite layer, and the composite layer being disposed on a surface of the substrate;
wherein a material of the substrate is an aluminum alloy, and the composite layer comprises an alloy layer;
wherein the alloy layer comprises at least three metals, the at least three metals comprise a zirconium, a copper and an aluminum;
wherein the composite element has a turning zone, a total length of the composite layer in the turning zone is LCc, a length of the turning zone is Lc, a thickness of the alloy layer is Ta, a thickness of the substrate is Ts, and the following conditions are satisfied:
$$0.75 \leq L C c / Lc ; and$$
$$0.5 \leq Ta / Ts \leq 1. .$$

2. The composite element of claim 1, wherein a weight percentage of the zirconium in the alloy layer is Pzr, a weight percentage of the copper in the alloy layer is Pcu, a weight percentage of the aluminum in the alloy layer is Pal, and the following conditions are satisfied:
$$60 \% \leq Pzr \leq 90 \%$$
$$5 \% \leq Pcu \leq 23 \% ; and$$
$$2 \% \leq Pal \leq 6 \% .$$

3. The composite element of claim 1, wherein a density of the alloy layer is Da, a density of the substrate is Ds, and the following condition is satisfied:
$$1. 5 \leq D a / D s \leq 3.5 .$$

4. The composite element of claim 1, wherein a coefficient of thermal conductivity of the alloy layer is TCa, a coefficient of thermal conductivity of the substrate is TCs, and the following condition is satisfied:
$$30 \leq T C s / T C a .$$

5. The composite element of claim 1, wherein a hardness of the alloy layer is Ha, and the following condition is satisfied:
$$400 HV \leq H a \leq 1000 HV .$$

6. The composite element of claim 5, wherein the hardness of the alloy layer is Ha, a hardness of the substrate is Hs, and the following condition is satisfied:
$$5. \leq Ha / Hs \leq 10. .$$

7. The composite element of claim 1, wherein the thickness of the alloy layer is Ta, and the following condition is satisfied:
$$0.5 mm \leq Ta \leq 1.5 mm .$$

8. The composite element of claim 1, wherein the composite structure further comprises:
a buffering layer located between the composite layer and the substrate.

9. The composite element of claim 1, wherein the composite element is a middle frame, and the composite element has a long edge area and a short edge area.

10. The composite element of claim 9, wherein the total length of the composite layer in the turning zone is LCc, the length of the turning zone is Lc, and the following condition is satisfied:
$$0.85 \leq LCc / Lc .$$

11. The composite element of claim 10, wherein a total length of the composite layer in the long edge area is LLc, a length of the long edge area is LI, and the following condition is satisfied:
$$0 < LLc / Ll \leq 0.15 .$$

12. The composite element of claim 11, wherein a total length of the composite layer in the short edge area is LSc, a length of the short edge area is Ls, and the following condition is satisfied:
$$0.05 \leq LSc / Ls \leq 0.15 .$$

13. A mobile device, comprising:
the composite element of claim 1, wherein the mobile device is a cell phone or a tablet computer.

14. A composite element, comprising:
a composite structure comprising a substrate and a composite layer, and the composite layer being disposed on a surface of the substrate;
wherein the composite layer comprises an alloy layer;
wherein the alloy layer comprises at least three metals, the at least three metals comprise a zirconium, a copper and an aluminum;
wherein an area of the composite layer in the composite element is Ac, an area of the substrate in the composite element is As, a thickness of the alloy layer is Ta, a thickness of the substrate is Ts, and the following conditions are satisfied:
$$0.2 \leq Ac / As ; and$$
$$0.2 \leq Ta / Ts \leq 2. .$$

15. The composite element of claim 14, wherein a weight percentage of the zirconium in the alloy layer is Pzr, a weight percentage of the copper in the alloy layer is Pcu, a weight percentage of the aluminum in the alloy layer is Pal, and the following condition is satisfied:
$$95 \% \leq Pzr + Pcu + Pal .$$

16. The composite element of claim 14, wherein a hardness of the alloy layer is Ha, and the following condition is satisfied:
$$300 HV \leq Ha .$$

17. The composite element of claim 16, wherein a hardness of the substrate is Hs, and the following condition is satisfied:
$$Hs \leq 250 HV .$$

18. The composite element of claim 17, wherein a density of the alloy layer is Da, a density of the substrate is Ds, and the following condition is satisfied:
$$Da / Ds \leq 5. .$$

19. The composite element of claim 18, wherein a coefficient of thermal conductivity of the substrate is TCs, and the following condition is satisfied:
$$5 W / mK \leq TCs .$$

20. The composite element of claim 19, wherein a coefficient of thermal conductivity of the alloy layer is TCa, the coefficient of thermal conductivity of the substrate is TCs, and the following condition is satisfied:
$$5 \leq TCs / TCa .$$

21. The composite element of claim 20, wherein a material of the substrate is an aluminum alloy, a titanium alloy or a stainless steel.

22. The composite element of claim 14, wherein the thickness of the alloy layer is Ta, and the following condition is satisfied:
$$0.3 mm < Ta .$$

23. The composite element of claim 14, wherein the composite element is a back panel or a front frame.

24. The composite element of claim 23, wherein the area of the composite layer in the composite element is Ac, the area of the substrate in the composite element is As, and the following condition is satisfied:
$$0.35 \leq Ac / As \leq 0.45 .$$

25. A mobile device, comprising:
the composite element of claim 23.

26. The composite element of claim 25, wherein the composite element has a turning zone, a long edge area and a short edge area, and the alloy layer is an amorphous alloy;
wherein a hardness of the alloy layer is Ha, a hardness of the substrate is Hs, a thickness of the alloy layer is Ta, the thickness of the substrate is Ts, a total length of the composite layer in the turning zone is LCc, a length of the turning zone is Lc, a total length of the composite layer in the long edge area is LLc, a length of the long edge area is LI, a total length of the composite layer in the short edge area is LSc, a length of the short edge area is Ls, and the following conditions are satisfied:
$$6. \leq Ha / Hs \leq 8. ;$$
$$0.6 \leq Ta / Ts \leq 0.9 ;$$
$$0.9 \leq LCc / Lc \leq 1. ;$$
$$0.05 \leq LLc / Ll \leq 0.1 ; and$$
$$0.1 \leq LSc / Ls \leq 0.13 .$$
